(19) United States
(12) Patent Application Publication
(10) Pub. No.: US 2005/0285972 A1
(43) Pub. Date: Dec. 29, 2005

(54) Imaging apparatus

(75) Inventor: Junichi Saiki, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: SONY CORPORATION, Tokyo (JP)

(21) Appl. No.: 11/153,336

(22) Filed: Jun. 16, 2005

(30) Foreign Application Priority Data
Jun. 25, 2004 (JP) 2004-188525

(51) Int. Cl. H04N 5/225

(52) U.S. Cl. 348/373

(57) ABSTRACT

The present invention provides an imaging apparatus which has a light-transmitting window section shaped like a hollow cylinder, which can therefore be easy to manufacture and in which the focal distance can be prevented from changing. The imaging apparatus includes a main body having a light-transmitting window section which is curved in one of directions in which the imaging apparatus is configured to rotate and which is shaped like a hollow cylinder, and an imaging device arranged in the main body, configured to be rotatable in one direction selected from directions consisting of panning direction and tilting direction and to photograph objects through the window section, and having a light-transmitting correction plate which is curved in a direction at right angles to the direction, in which the window section is curved which has the same bending radius as the window section, and which is shaped like a hollow cylinder.

### CROSS REFERENCES TO RELATED APPLICATIONS

The present invention contains subject matter related to Japanese Patent Application JP 2004-188525 filed in the Japanese Patent Office on Jun. 25, 2004, the entire contents of which are incorporated herein by reference.

### BACKGROUND OF THE INVENTION

1. Field of the Invention

The present invention relates to an imaging apparatus that may be used as a monitor camera.

2. Description of the Related Art

Monitor cameras remain installed indoors or outdoors for a long time. They comprise a main body, i.e., housing, and an imaging apparatus each. The imaging apparatus is incorporated in the main body. The main body has a light-transmitting window section. The imaging apparatus provided in the main body can photograph objects existing outside the main body. It is necessary for the monitor camera to scan a broad area. This is why the imaging apparatus provided in the main body has a pan mechanism and a tilt mechanism. Jpn. Pat. Appln. Laid-Open Publication No. 2000-244781 discloses a monitor camera. The main body of this monitor camera has a dome-shaped window section, through which the imaging apparatus provided in the main body can photograph objects existing outside the main body.

The size of the window section determines the area that the monitor camera can scan. Hence, the monitor camera must have a large window section to scan a broad area. The window section of the monitor camera disclosed in Publication No. 2000-244781 is made of light-transmitting resin and has a spherical surface. Having a spherical surface, the window section converges, at one point, the light incident to the imaging element of the imaging apparatus, though the window section lies between the imaging apparatus and any object outside the main body. Thus, the window section is easy to design in terms of optics. If the window section has a central angle of 180° or more, defining a spherical surface, however, its molding is extremely difficult. That is, the window section can hardly be released from the mold in injection molding, and can hardly acquire a uniform thickness in blow molding.

As FIGS. 1A and 1B show, the window section 101 may be curved in the form of a hollow cylinder. In this case, the section can be easily released from the mold even if its central angle is 180° or more and can therefore be easily formed by injection molding. If the window section 101 is shaped like a hollow cylinder, however, the following problem will arise. Its focal distance to the imaging element 104 such as a charge-coupled device (CCD) will be displaced due to the difference in refracting angle between light beams 102 and 103 that travel horizontally and vertically, respectively. Consequently, the window section 101 cannot focus both light beams on the imaging element 104, failing to form a focused image on the element 104. That is, the light beam 102 horizontally traveling can be focused on the imaging element 104 as is illustrated in FIG. 1A. On the other hand, the light beam 103 vertically traveling cannot be focused on the imaging element 104, because it is refracted as it passes through the window section 101 and the focal distance inevitably changes as is illustrated in FIG. 1B.

### SUMMARY OF THE INVENTION

The present invention has been made in view of the foregoing. It is desirable to provide an imaging apparatus which has a window section shaped like a hollow cylinder, and which can therefore be easy to manufacture and in which the focal distance can be prevented from changing.

An imaging apparatus according to this invention includes a main body having a light-transmitting window section which is curved in one of directions in which the imaging apparatus is configured to rotate and which is shaped like a hollow cylinder, and an imaging device arranged in the main body, configured to be rotatable in one direction selected from directions consisting of panning direction and tilting direction and to photograph objects through the window section, and having a light-transmitting correction plate which is curved in a direction at right angles to the direction, in which the window section is curved which has the same bending radius as the window section, and which is shaped like a hollow cylinder.

According to the present invention, the vertically traveling light beam is refracted while passing through the window section, and the horizontally traveling light beam is refracted in the same manner while passing through the correction plate. Both light beams are therefore focused on the imaging element, after traveling the same focal distance.

### BRIEF DESCRIPTION OF THE DRAWINGS

FIG. 1A is a plan view of an imaging apparatus, showing how light is refracted when the window section is made of synthetic resin and shaped like a hollow cylinder;

FIG. 1B is a side view of the imaging apparatus, also showing how light is refracted;

FIG. 2 a diagram illustrating a monitor camera according to the present invention, which is being used;

FIG. 3 is a perspective view of the monitor camera;

FIG. 4 is a perspective view of the monitor camera, depicting the internal structure of the camera;

FIG. 5 is a diagram showing an area that the monitor camera can photograph;

FIG. 6A is a plan view of the monitor camera, showing how light is refracted; and

FIG. 6B is a side view of the monitor camera, also showing how light is refracted.

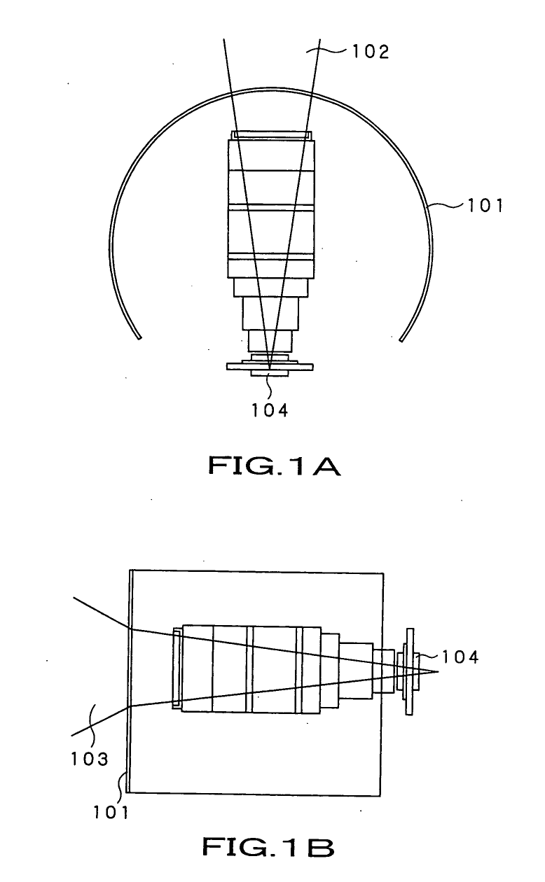

### DETAILED DESCRIPTION OF THE PREFERRED EMBODIMENTS

A monitor camera according to the present invention will be described, with reference to the accompanying drawings.

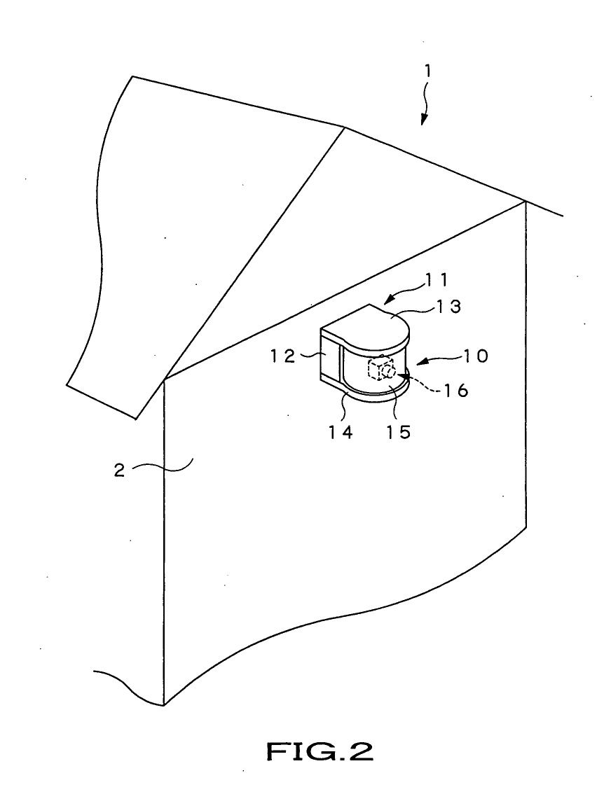

The monitor camera 10 according to this invention is designed for outdoor use. As FIG. 2 shows, the monitor camera 10 is installed on the top part of the outer wall 2 of a building 1 such as a warehouse. It is located near the roof of the building. So located, it can photograph a broad area, scanning the area downwards and slantwise.

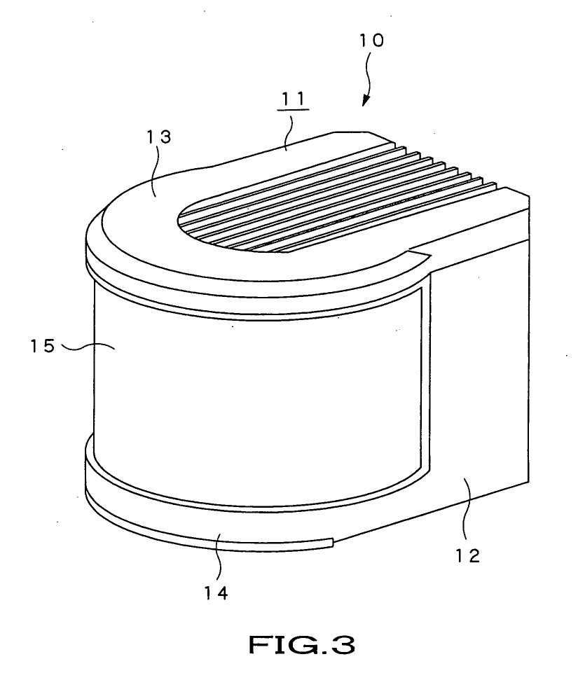

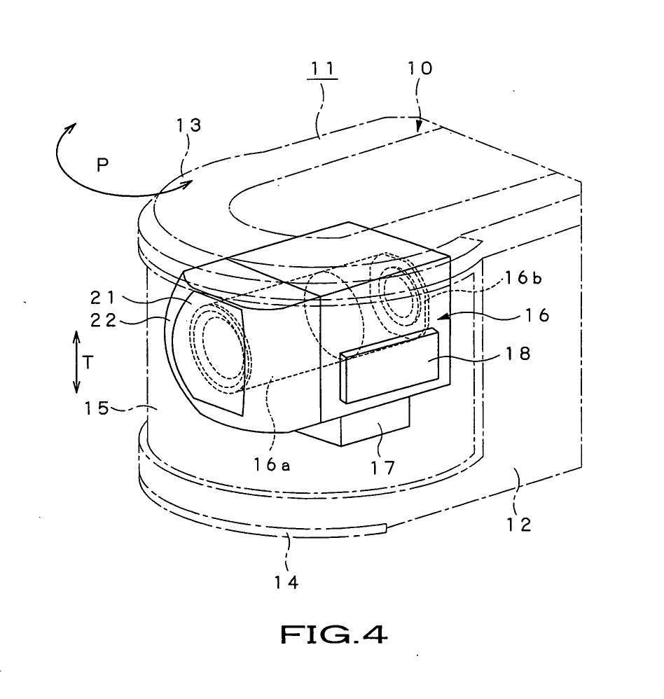

As FIGS. 3 and 4 show, the monitor camera 10 has a main body 11. The main body 11 comprises a main section 12, a ceiling section 13, and a bottom section 14. The main section 12 is almost rectangular. The ceiling section 13 is mounted on the top of the main section 12. The bottom section 14 is secured to the bottom of the main section 12. The main section 12 has a window section 15 in the front.

As mentioned above, the main section 12 is almost rectangular. Its back is substantially flat so that the main section 12 can be secured to the outer wall 2 of the building 1. The main section 12 mainly contains a control circuit section that controls the entire monitor camera 10, a power-supply circuit section, and the like.

As FIGS. 3 and 4 show, the ceiling section 13 is arranged on the top of the main section 12. The distal end of the ceiling section 13 is arcuate, extending forwards beyond the window section 15 and serving as the roof of the window section 15.

As indicated above, the bottom section 14 is secured to the bottom of the main section 12. Like the ceiling section 13, the bottom section 14 has a distal end that are almost arcuate. The bottom section 14 may be put on a base. In this case, it functions as support base of the monitor camera 10. Like the distal end of the ceiling section 13, the distal end of the bottom section 14 extends forwards beyond the window section 15, serving as a guard that prevents foreign matter from sticking to the window section 15. The bottom section 14 contains the pan mechanism, etc. of the imaging device 16 that is incorporated in the main section 11.

The window section 15 is provided in front of the main section 12. The widow section 15 is a plate made of light-transmitting synthetic resin. As seen from FIG. 4, the window section 15 contains the imaging device 16. The imaging device 16 contains a digital still camera that is constituted by, for example, a CCD or a CMOS sensor. The imaging device 16 has a zooming function and can provide magnified images of remote objects. Having a zooming function, the imaging device 16 has a small view angle. Thus, the imaging device 16 has a pan mechanism 17 and a tilt mechanism 18. Of these mechanisms, at least pan mechanism 17 can rotate the imaging device 16 through 180° or more. The monitor camera 10 can therefore scan a broad area.

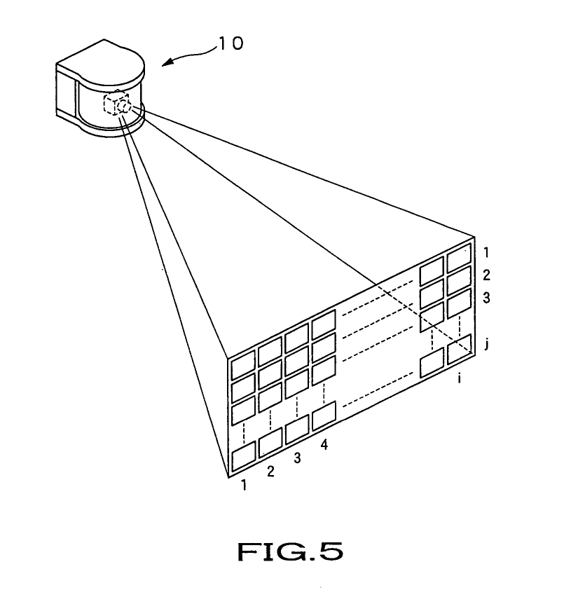

As shown in FIG. 5, the imaging device 16 is rotated up and down, from the left to the right, or vice versa, by the pan mechanism 17 and tilt mechanism 18. Every time the device 16 is rotated, for example, from the left to the right, it provides images 1 to i. Every time the device 16 is rotated, for example, downwards, it provides 1 to j images. As a result, the monitor camera 10 generates data representing i×j images, forming a matrix. The data is supplied to an image display, which displays the i×j images at a time. The monitor camera 10 arranges the images thus photographed, in time sequence. Hence, the person who sees the images displayed can easily recognize changes, if any, in the area that is monitored.

The imaging device 16 is not limited to a digital still camera. It can be an analog still camera. Alternatively, it can be a digital video camera or an analog video camera.

As FIG. 4 shows, the window section 15 provided in the front of the lens barrel 16a of the imaging device 16. The window section 15 is made of a plate of light-transmitting synthetic resin. It is curved in the panning direction P and thus shaped like a hollow cylinder. The window section 15 has a central angle of 180° or more, because the imaging device 16 can be panned through 180° or more. Shaped like a hollow cylinder, the window section 15 can easily have a uniform thickness.

As specified above, the window section 15 is curved in the panning direction (the direction of arrow P in FIG. 4) and is thereby shaped like a hollow cylinder. Therefore, the horizontally traveling light beam and the vertically traveling light beam differ in refractive index. Consequently, the focal distance for the vertically traveling light beam differs from the focal distance to the horizontally traveling light beam.

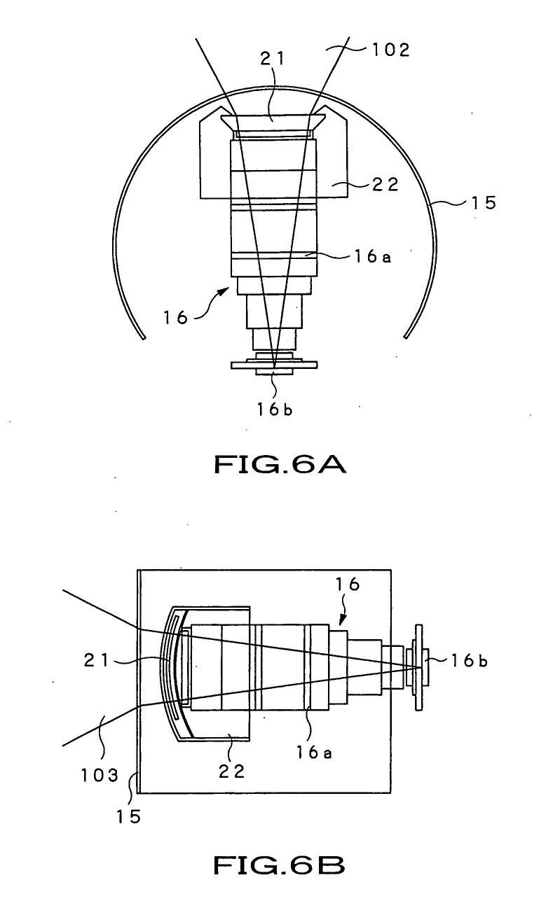

Thus, a correction plate 21 for correcting the focal distance is attached to the front of the lens barrel 16a of the imaging device 16 by a holder 22. The correction plate 21 is a light-transmitting plate curved in the tilting direction (the direction of arrow T in FIG. 4) that is at right angles to the panning direction. The plate 21 is shaped like a hollow cylinder and has the same bending radius as the window section 15. As shown in FIG. 6A, the horizontally traveling light beam 102 passes through the window section 15, without being refracted. It is refracted while passing through the correction plate 21 and is focused on the imaging element 16b. As illustrated in FIG. 6B, the vertically traveling light beam 103 is refracted while passing through the window section 15. It passes through the correction plate 21, without being refracted, and is focused on the imaging element 16b. Thus, the horizontally traveling light beam 102 and the vertically traveling light beam 103 are refracted only once, either in the correction plate 21 and the window section 15. This is because the window section 15 and the correction plate 21 are curved in the form of a hollow cylinder, have the same bending radius and refract the light beams at the same angle. As a result, the focal distance for the vertically traveling light beam and the focal distance for the horizontally traveling light beam become equal.

In the monitor camera 10 described above, the window section 15 is a plate made of light-transmitting synthetic resin and curved in the form of a horizontal cylinder. The imaging device 16 provided in the main section 11 can therefore be rotated through 180° or more in the panning direction. This expands the area that the monitor camera 10 can photograph. Since the window section 15 is a synthetic resin plate curved and shaped like a hollow cylinder, the horizontally traveling light beam and the vertically traveling light beam are inevitably different in terms of refractive index. Nonetheless, the horizontally traveling light beam and the vertically traveling light beam can be refracted once in the same way. This is because the correction plate 21 attached to the imaging device 16 is curved in the tilting direction that is at right angles to the direction (i.e., panning direction), in which the window section 15 is curved, and has the same bending radius as the window section 15. Hence, any light beam can be focused on the imaging element 16b, in whichever direction it travels. This prevents any image photographed from being degraded.

The monitor camera 10 according to this invention has been described. Nevertheless, the present invention is not limited to a monitor camera. The invention can be applied to, for example, a portable digital still camera, a portable analog still camera, and a video camera.

Moreover, the window section 15 may be curved in the tilting direction in the form of a hollow cylinder, and the correction plate 21 may be curved in the panning direction in the form of a hollow cylinder. In this case, too, the advantages described above can be achieved.

It should be understood by those skilled in the art that various modifications, combinations, sub-combinations and alterations may occur depending on design requirements and other factors insofar as they are within the scope of the appended claims or the equivalents thereof.

1. An imaging apparatus comprising:
a main body having a light-transmitting window section which is curved in one of directions in which the imaging apparatus is configured to rotate and which is shaped like a hollow cylinder; and
an imaging device arranged in the main body, configured to be rotatable in one direction selected from directions consisting of panning direction and tilting direction and to photograph objects through the window section, and having a light-transmitting correction plate which is curved in a direction at right angles to the direction, in which the window section is curved which has the same bending radius as the window section, and which is shaped like a hollow cylinder.

2. The imaging apparatus according to claim 1, wherein the window section has a central angle of at least of 180° in the panning direction.
